(19) United States
(12) Patent Application Publication
(10) Pub. No.: US 2020/0281060 A1
(43) Pub. Date: Sep. 3, 2020

(54) ADAPTIVE CURRENT LED DRIVER CIRCUIT

(71) Applicant: McWong Inc., Sacramento, CA (US)

(72) Inventors: Darren Musgrove, Sacramento, CA (US); Andrew Judy, Sacramento, CA (US)

(73) Assignee: McWong Inc., Sacramento, CA (US)

(21) Appl. No.: 16/873,233

(22) Filed: Feb. 28, 2020

Related U.S. Application Data
(60) Provisional application No. 62/919,215, filed on Mar. 1, 2019.

(51) Int. Cl. H05B 45/345

(52) U.S. Cl. CPC H05B 45/345

(57) ABSTRACT

A LED lighting system with an adaptive current LED driver circuit is disclosed. The adaptive current LED driver circuit includes a LED driver for powering a LED light fixture and an adaptative circuit. The adaptive circuit includes a measuring circuit and a CPU or micro-processor for running adaptive software that computes operating currents and/or operating voltages of the LED driver and adjusting operating line current values of the LED driver meet optimal power requirements of the LED light fixture.

### RELATED APPLICATION

This application claims priority under 35 U.S.C. § 119(e) from the co-pending U.S. provisional patent application Ser. No. 62/919,215, filed on Mar. 1, 2019, and titled “ADAPTIVE CURRENT LED DRIVER CURRENT CIRCUIT.” The co-pending U.S. provisional patent application Ser. No. 62/919,215, filed on Mar. 1, 2019, and titled “ADAPTIVE CURRENT LED DRIVER CURRENT CIRCUIT” is hereby incorporated by reference.

### FIELD OF THE INVENTION

The invention relates to LED lighting systems. More particularly, the present invention relates to an adaptive current LED driver circuit for powering LED lighting systems.

### BACKGROUND OF THE INVENTION

An LED driver is an electrical circuit used to power light-emitting diodes (LEDs) or arrays of LEDs. The circuit must provide sufficient current to power the LEDs, or arrays of LEDs, at a target brightness but with a limited current such as to not damage the LEDs or arrays of LEDs.

Because the voltage drop across LEDs or LED arrays is approximately constant over a wide range of operating currents a small increase in applied voltage greatly increases the current. Therefore, it is important the LED driver operates within the current suitable for lighting system.

In order to maintain the proper operating current, there are a number of different LED drivers to select from depending on the lighting system requirements.

### SUMMARY OF INVENTION

The present invention is directed to an adaptive current LED driver circuit. The adaptive current LED driver circuit detects a forward voltage of a connected LED load from an LED light and then automatically sets a constant output drive current that is required to power the LED light. The adaptive current LED driver allows a broad range of DC voltage loads to be used with a single LED driver. The adaptive current LED driver circuit can be integrated into an LED driver or can be placed in-line with an LED driver circuit.

The adaptive current LED driver circuit can include a Wireless Radio (such as Bluetooth) that enables remote settings of the maximum power level of the adaptive LED driver circuit allowing, for example, 50 W driver to be coupled to loads below 50 W. Optionally, the Bluetooth control could be used to set a maximum drive current rather than or in addition to a maximum power. This maximum output power setting would not take the place of the optional 0-10V dimming lead wires used to further dim lighting from that maximum power state, or even dimming to off.

In operation the adaptive current LED driver circuit monitors the LED light string voltage and determines the optimal current to drive the LEDs in the LED light by location the linear portion 201 of the LED string voltage and regulating the current at that value; for example, in FIG. 2A the optimum current is 700 mA.

The adaptive current LED driver circuit provide a number of advantages including, but not limited to, reducing the need to program individual LED drivers to operate at the out put voltage for a particular LED light fixture, it allows any given LED driver and corresponding lighting system to operate with high efficiency, a single LED driver can be used for a number of different LED light fixtures with different power requirements, and with Bluetooth control integrated into the system, there is the ability to monitor lighting performance and manage energy consumption.

While the present invention is primarily described for optimizing the operation of LED lights, the adaptive current circuitry described has other applications including, but not limited to, running and controlling battery powered back-up LED driver circuits and any other application where automated control of line current is useful or required.

### BRIEF DESCRIPTION OF THE DRAWINGS

FIG. 1 shows a schematic representation of an LED lighting system with an adaptive current LED driver circuit, in accordance with the embodiments of the invention.

FIG. 2 shows a table of the operational parameters for a 50 W LED driver circuit with an output voltage range of 20V to 80V, when used with the adaptive LED driver circuit of the present invention.

FIGS. 3A-B shows graphs of forward line voltage matched with forward current measured to determine the optimal operating forward current for powering a LED light fixture, in accordance with the method of the invention.

FIGS. 4A-B show schematic representations of a LED circuit with the an adaptive current LED driver circuit, in accordance with the embodiments of the invention.

FIG. 5 shows schematic of a back-up battery adaptive current circuit, in accordance with the further embodiments of the invention.

FIG. 6 shows a block-flow diagram outlining the steps controlling forward operating current of an LED driver to maintain an optimal forward operating voltage, in accordance with the method of the present invention.

### DETAILED DESCRIPTION OF THE INVENTION

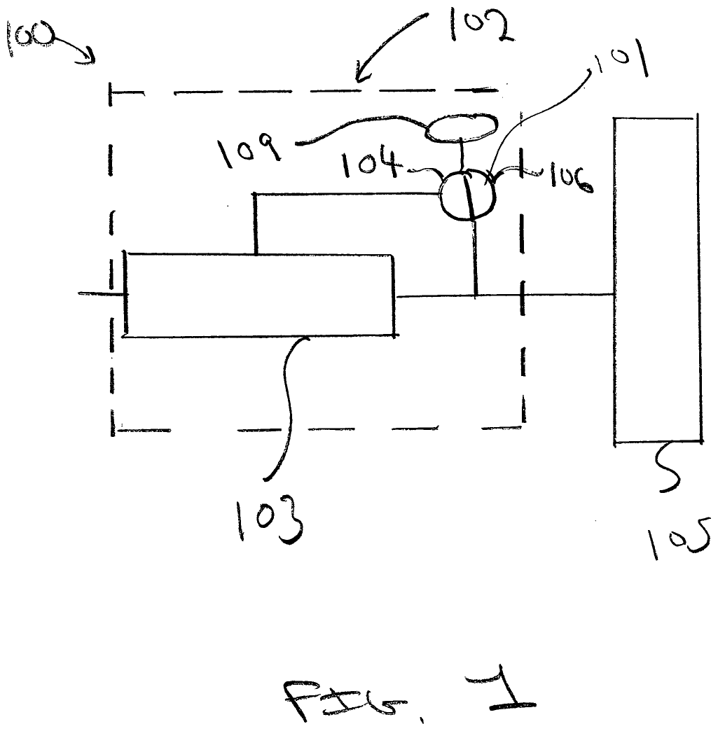

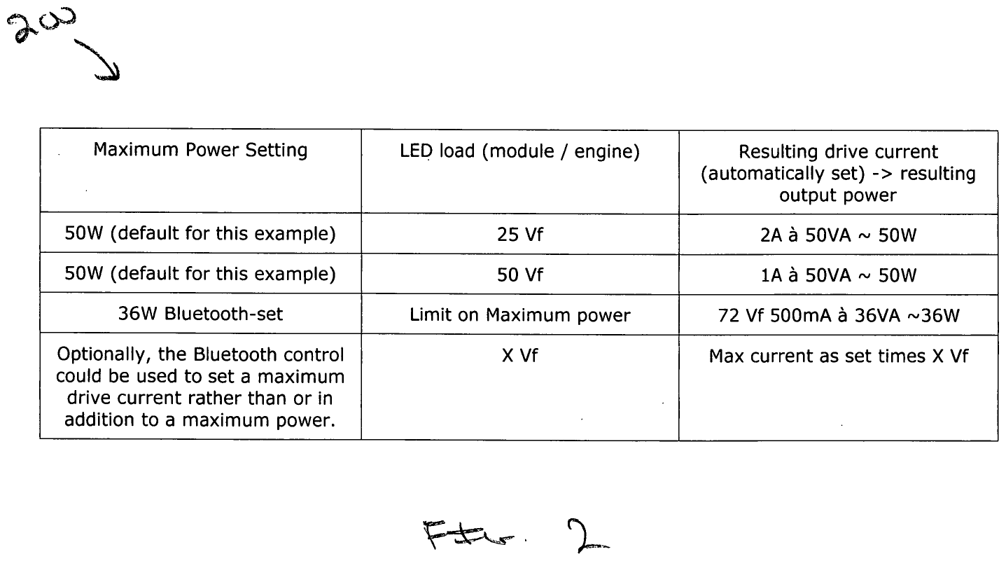

FIG. 1 shows a schematic representation of an LED lighting system 100 with an adaptive current LED driver circuit 102. The adaptive current LED driver circuit 102 includes a LED driver 103 and an adaptative circuit 101. The adaptive circuit 101 includes a measuring circuit 104 and a CPU or micro-processor 106 for running adaptive software for computing operating currents and/or operating voltages of the LED driver 103 and adjusting operating line current values of the LED driver 103. The adaptative circuit 101 can be integrated with the LED driver 103 or placed in-line with the LED driver 103 and an LED light fixture 105.

In operation the measuring circuit 104 of the adaptive circuit 101 measures or monitors the line operating current values from the LED driver 103 provided to the LED light fixture 105. The measuring circuit 104 of the adaptive circuit 101 also measures or monitors corresponding forward line operation voltage values from the LED driver 103. The CPU or micro-processor 106 determines an optimal or stable operating line voltage value for operating the LED light fixture 105 and automatically adjusts the line operating current (optimal current value) to maintain that optimal or stable forward line operating voltage.

As described above the adaptive LED driver circuit 101 allows for optimal operation of the LED light fixture 105 thereby adding longevity to the life time of the light fixture 105 and helps to maintain low or optimal energy consumption of the LED light fixture 105. Where the LED lighting system 100 is equipped with the radio receiver/transmitter 109, such a Bluetooth transponder) coupled to the adaptive circuit 101, the LED driver circuit 109 can be commissioned remotely to operate according to preset power conditions and/or can provide historical analytics of the operating performance of the LED light fixture 105.

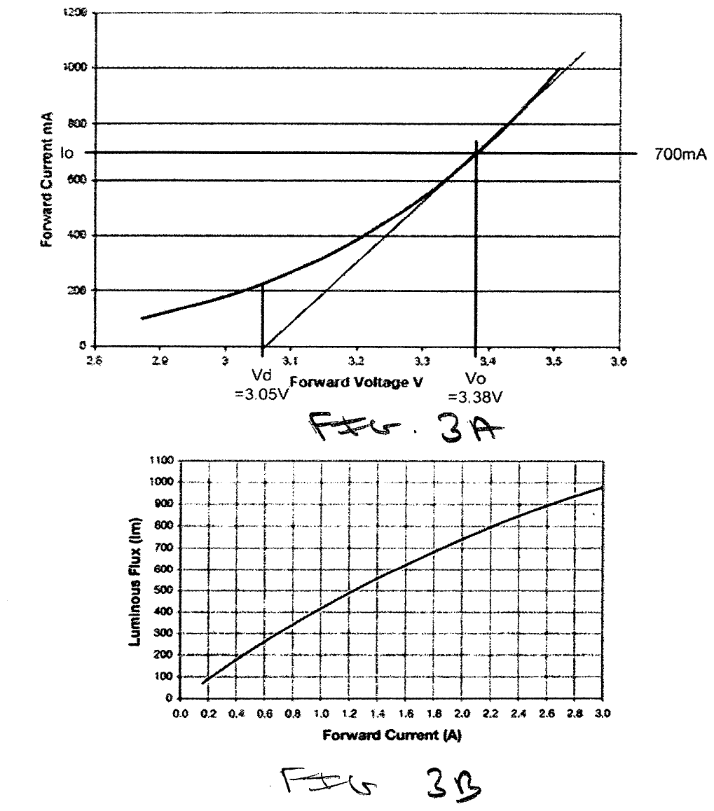

FIG. 2 shows a table 200 of the operational parameters for a 50 W LED driver circuit with an output voltage range of 20V to 80V. From the table it can be seen that a 50 W LED driver circuit can be used to accommodate a range of power requirement or conditions using the with adaptive circuit 101 (FIG. 1) of the present invention.

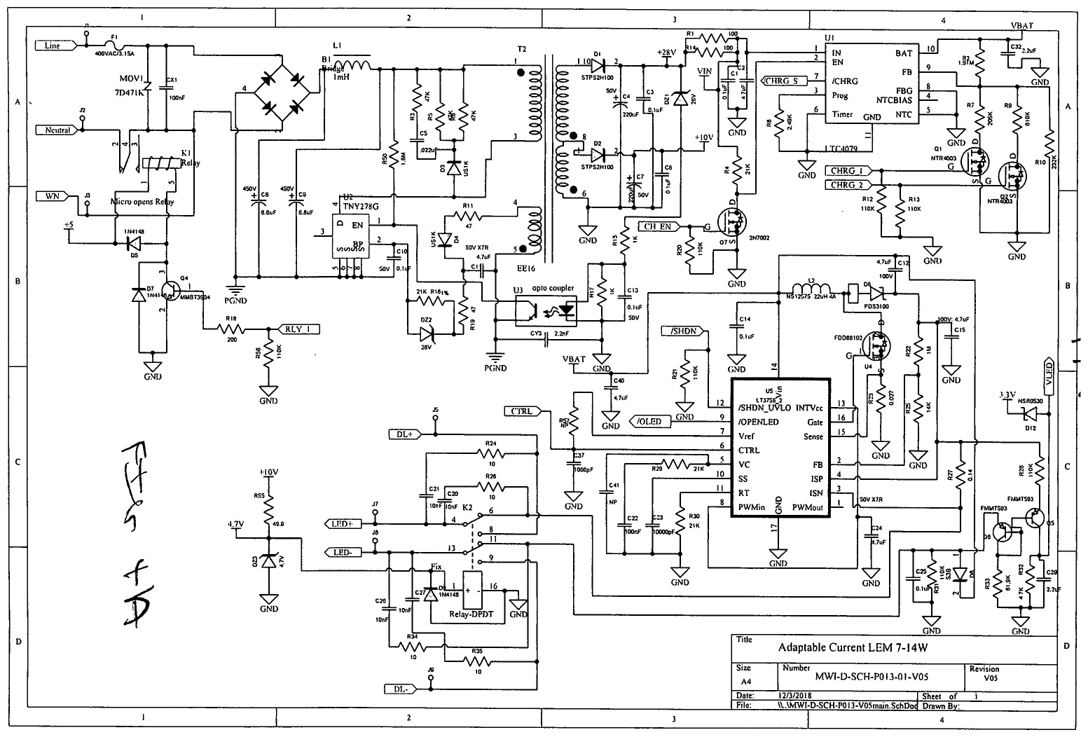

FIGS. 3A-B shows graphs of the forward operating line current (FIG. 3B) measured or monitored by the measuring circuit 104 of the adaptive circuit 101 (FIG. 1) and the forward operating voltage (FIG. 3A), plotted against forward operating line current. In operation the CPU or micro-processor 106 sued software to determine the linear portion of the forward operating current/voltage curve and sets the operating forward current of the LED driver to operate at that value.

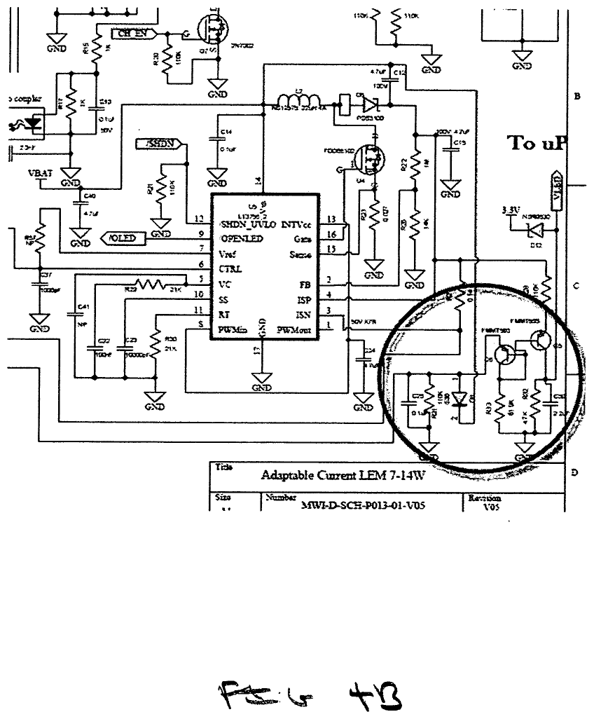

FIGS. 4A-B show schematic representation of an LED circuit with the an adaptive current LED driver circuit, in accordance with the embodiments of the invention.

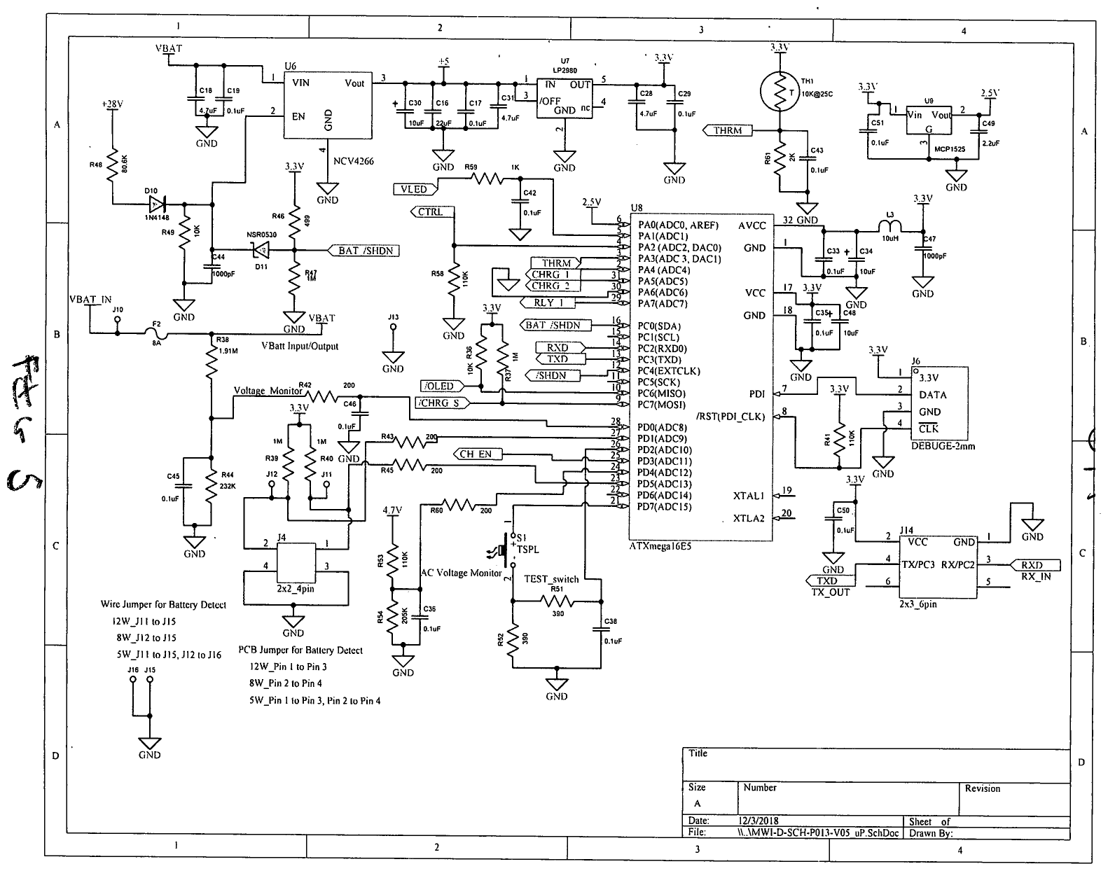

FIG. 5 shows schematic of a back-up battery adaptive current circuit, in accordance with the further embodiments of the invention.

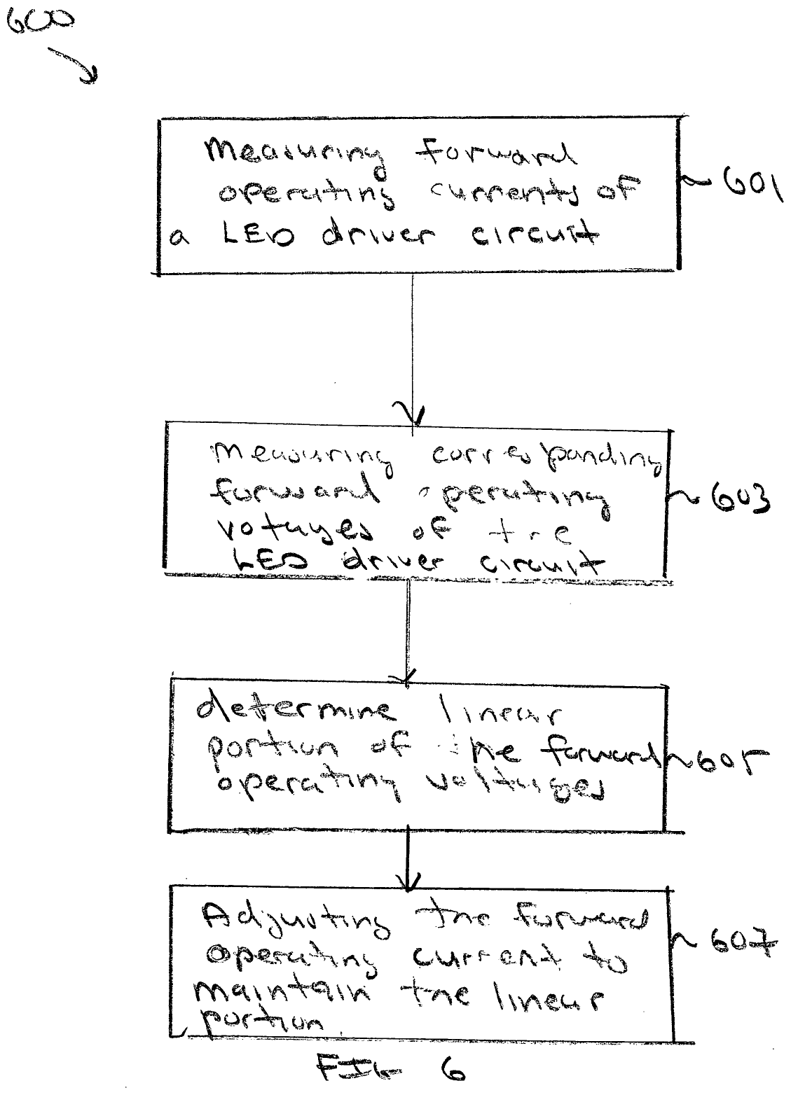

FIG. 6 shows a block-flow diagram 600 outlining the steps controlling forward operating current of an LED driver to maintain an optimal forward operating voltage, in accordance with the method of the present invention.

What is claimed is:

1. A LED lighting system comprising:
a) a LED light fixture; and
b) an adaptive current LED driver circuit for controlling the LED light fixture, the adaptive current LED driver circuit comprising:
I) an LED driver; and
ii) an adaptive LED driver circuit that monitors forward line voltage values of LED driver and sets the forward line current at an optimum current value for powering the light fixture.
